(19) United States
(12) Patent Application Publication
(10) Pub. No.: US 2004/0059711 A1
(43) Pub. Date: Mar. 25, 2004

(54) Configuration of a flexible infrastructure

(76) Inventors: Magnus Jandel, Vasby (SE); Jonas Jonsson, Ekero (SE)

Correspondence Address: YOUNG & THOMPSON, 745 SOUTH 23RD STREET 2ND FLOOR, ARLINGTON, VA, 22202

(21) Appl. No.: 10/415,080

(22) PCT Filed: Oct. 22, 2001
(86) PCT No.: PCT/SE01/02308

(30) Foreign Application Priority Data
Oct. 27, 2000 (SE) 0003926-3

(51) Int. Cl. G06F 7/00

(52) U.S. Cl. 707/1

(57) ABSTRACT

A configuration arrangement, data processing system and a computer program product for flexible communication infrastructure for a multi-user application to be provided to a programmable application network. Each user is a client comprising a client computer and is able to participate in the application as a session participant. Human supervising commanding operator after installation of the configuration elements should be essentially avoided. At least one session profile comprises a set of application network parameters valid for an application session (APS). The session profile initializes and prepares the programmable application network in connection with or before the start of the application session. Each of a number of client profiles comprises a set of application network parameters valid for the client participating in an application session.

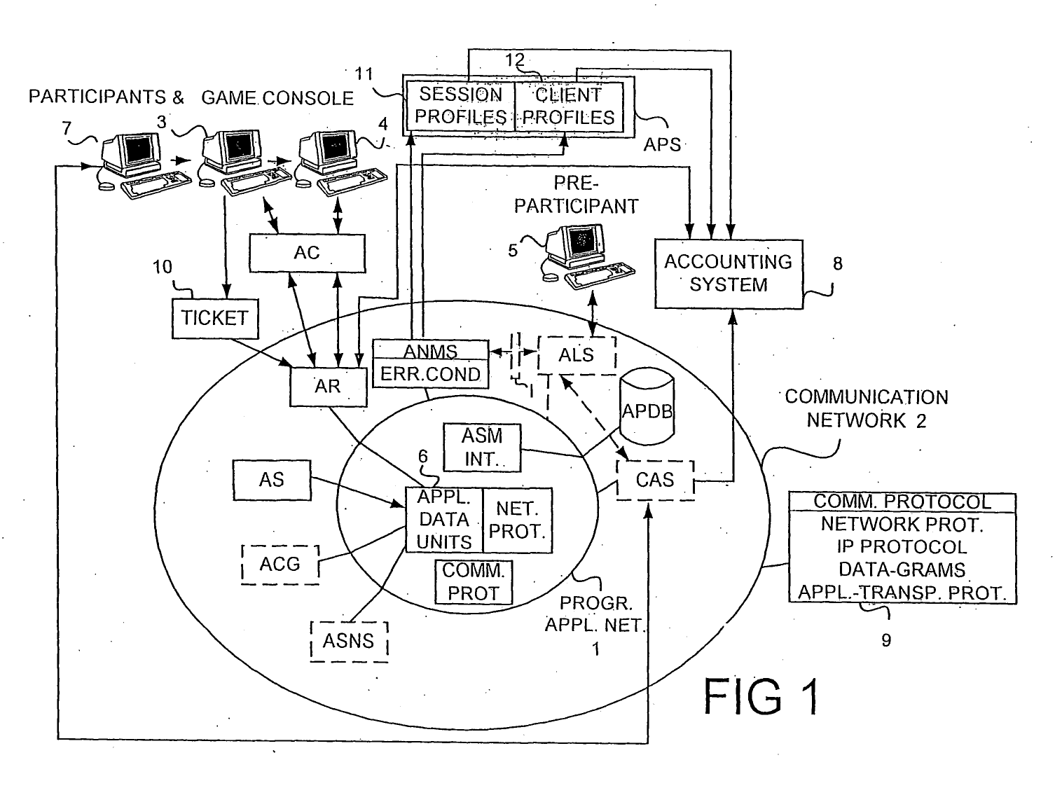

This invention relates to a configuration device of a flexible communication infrastructure for multi-user applications of the kind stated in the preamble of claim 1, and a method for making the configuration.

### TECHNICAL FIELD

The application for the invention is networked virtual environments where widely distributed, multiple users interact in real-time. An application is here defined as a distributed computer process that is processing a networked virtual environment. Such applications aim for a sense of realism and an intensified (immersed) experience in a virtual world. They are used for military and industrial team training, collaborative design and engineering, multi-player games, virtual shopping, virtual conferences, remote customer support and distance learning. An application session is an instance of an application started at a given point in time. Clients can join, rejoin and leave the application session. The application session is terminated under some predefined conditions.

### DESCRIPTION OF RELATED ART

PCT/SE00/00932 “Application Access Server”, having the priority date 1999-0510 from both SE 9901694-1 and U.S. Ser. No. 09/307,712, is a co-pending application, which describes a real-time performance in a communication network between a large number of participants. A server unit is provided comprising receiving means for receiving information from the client units. The server unit stores state information received from each of the client units and forwards this information to nodes in the network. It also transmits at least a part of the stored information to the clients. In this way the whole state of an application can be kept in one or more units in the network. This removes the need for each client to store the entire state, thereby reducing memory and bandwidth requirement for each client.

The present invention is based on the co-pending PCT/SE00/00932 but performs a semi-automatic configuration of the infrastructure for multi-user applications.

Simultaneously with this application are the co-pending applications SE- . . . Infrastructures) “Communication Infrastructure for Multi-user” and SE- . . . . Name Server) “Name Service for Networked MULTI-USER Applications”.

Some of the elements shown and discussed in this application are discussed in more detail in the co-pending applications, which are hereby incorporated by reference in its entirety for all and any purposes.

### OBJECTS OF THE INVENTION

An object of the invention is to provide a semi-automatic configuration of a flexible communication infrastructure for multi-user applications.

Another object of the invention is to provide improved quality and economic use of network resources.

The Invention

A session profile consists of a set of application network parameters valid for/applied on an application session. The session profile is used to initialize and prepare the programmable application network before or in connection with an application session is started. A client profile consists of a set of application network parameters valid for a participant in an application session. The client profile is used to initialize and prepare the programmable application network and the client computer before or in connection with a given client joins the application session.

A set of client profiles may be associated to a session profile. Each application is optionally associated to one or several client profiles and application session profiles.

If the programmable application network does not support the application with a session management interface, the session and client profiles associated with the application gives the run-time conditions for the application session.

Session participants may join the session without having been provided with a particular session access ticket by the programmable application network (PAN). Session participants use the application name and/or the application session profile identity and/or the client profile identity as session access ticket and/or an identity assigned to each client access possibility (for example consecutive numbers 1 . . . 10, if clients are able to be connected with a certain client profile). This could be an optional part of a session access ticket in the case when only client type/session type is used a access ticket. This information may be encoded according to any feasible method. It makes it possible for the programmable application network to perform a simple authorization test of the client and at the same time set the client specific parameters. A simple authorization test could comprise that the client must know possible client profile names and/or session profile names and/or application names. Client specific parameters are provided in the client computer when the client is connected. These parameters are preferably provided in the programmable application network PAN before the client is connected but are associated to the client at the connection.

If the programmable application network PAN is configured in accordance with the invention a pre-configure could be provided by an application lobby server ALS, if a session management interface is used, or by a manual configuration of the system with this feature if there is no session management interface.

The programmable application network PAN could be open for connection of clients in a number of sessions for a number of applications. A client can connect by enclose a session access ticket, which points out the application session type and client type {for example 1) A+S+E:12, or 2) S+E if S is associated only to A, or 3) E if E is associated only to S or S is associated only to A, or 4) A if the client does not bother about the session type or client type}.

It is possible to provide still other identities, for example a number, on each ticket. If P=18 then this implies that a A+S+E:12 (or a connection possibility for number 12 of 18 possible). Se session type is just pointed out and not the specific session. If N=5, this implies that a ticket as A+S:4+E:12 or A+S+E:66 (of 18*5=90) (or connection possibility for 66 from the 90 possible). A specific session is pointed out, such as number 4 from the 5 possible. Thus, a session ticket could be constructed such that there are room for hybrids.

The system could be pre-configured for a number of different applications of the type A, B etc. For the application A: the number of N sessions having the session profile S, the number of M sessions having the session profile T etc. For session with the session profile S: the number of P clients having the client profile E, the number on Q clients having the client profile F etc.

If the programmable application network support the application with a session management interface the session and client profiles together with the alterations to these agreed upon by the client gives the run-time conditions for the application session. Session participants can join the session using the session access ticket provided by the programmable application network.

A user that wishes to initiate an application session negotiates the use of a certain session profile with the programmable application network. A user that wishes to join an application session negotiates the use of a certain client profile with the programmable application network.

Advantages

The invention enables that sufficient resources in the communication network and in all nodes of the programmable application network are allocated. This means that high and consistent end-user quality is guaranteed. The allocated resources are precisely tailored to the needs of the application. No wasteful over-provisioning is needed. Almost no human intervention is needed since the client and session profiles can be pre-prepared and used automatically.

The invention also gives a flexible way to set up sessions in the programmable application network both with and without the use of the Session management interface. The sign-on procedure using session access tickets is the same in these two cases.

### BRIEF DESCRIPTION OF DRAWING

For a more complete understanding of the present invention and for further objects and advantages thereof, reference is now made to the following description of an embodiment thereof as shown in the accompanying drawing. The Figure illustrates a logic picture of a programmable application network (PAN) suitable for supporting networked virtual environments for the invention.

### DETAILED DESCRIPTION OF A PREFERRED EMBODIMENT

Programmable Application Network (PAN)

A programmable application network 1 suitable for supporting networked virtual environments is shown in the Figure. It is a part of a communication network 2, for example included in an internet, an intranet or the like or being a private network. The communication network 2 comprises communication links and routers for general-purpose communication protocols, for example Internet protocols.

The communication network 2 includes also several nodes AC, ANS, ACG, AR, AS, APDB, ALS, ANMS, CAS that are dedicated for supporting an application session APS. Not all such nodes must be present in a given application session. Nodes that are optional are shown with dashed lines, like optional connections. Several instances of a given node type may be present.

The programmable application network 1 can be programmed or configured to support a given application session APS and to serve a given set of clients 3, 4, 7, one of them could have the role of a game console as well, as will be explain below. The network 1 then sets application network parameters so that sufficient bandwidth, network addresses, server memory, server computing power, application content generator capacity, application session name server capacity etc are allocated. The nodes of a programmable application network 1 are described in detail below.

Application Lobby Server (ALS) (Optional)

The optional ALS is used for setting up the application session APS. All optional nodes have dashed lines in the Figure. It is to be noted that the application lobby server need not be a part of the programmable application network (PAN) and instead be an external element connected to the network. Participants 5 in spe (pre-participants) could register at the ALS and negotiate with the programmable application network 1 through the application network management system ANMS (described below) to start an application session APS. An application service provider might use the ALS to authenticate participants and to handle accounting.

Application Network Management System (ANMS)

The application network management system ANMS is used for initializing application sessions APS that may have been negotiated at the ALS. It is optional to have an application session management interface I between the ALS and the ANMS.

If the programmable application network 1 support the application with a session management interface I, the session and client profiles 11, 12 together with the alterations to these agreed upon by the Client gives the run-timed conditions for the application session APS.

If the session management interface I is provided then the access ticket is the same as in case no session management interface I is provided,

The application network management system ANMS is used for reserving resources, optionally in the communication network 1 and at AS, AR, ACG and ASNS nodes (see below). The application network management system ANMS might also be used for handling error conditions.

In accordance with the invention the application network management system ANMS is using at least one session profile 11 and at least one client profile 12 for configuring the programmable application network 1.

Session profile 11

A session profile 11 may include a set of application network parameters valid for an application session APS. The session profile 11 is used to initialize and prepares the programmable application network 1 before or in connection with an application session APS is started. A session profile 11 may include parameters specifying:

1) The maximum total usage of network resources for the session including bandwidth between the various nodes AC, ANS, ACG, AR, AS, APDB, ALS, ANMS, CAS in application network 1, memory usage in the various nodes of the application network 1.

2) Communication protocol and application transport protocol settings and sizes of protocol fields and application tags.

3) The maximum number of clients 3, 4 and client groups. Client groups are sets of clients known to the application network 1. Client groups can be used e.g. for multicasting application data.

4) Parameters that determine the global behavior of the session APS, such as under what conditions the session is automatically terminated.

5) A default client profile.

6) The total allowed session time and various time-out settings.

Client Profiles 12

There could be a number of client profiles 12, each comprising a set of application network parameters valid for a participant in an application session APS. Each client profile 12 initializes and prepares the programmable application network 1 and the client computer 5 before a given client joins the application session APS. The client profile 12 limits the number of resources a given client 3, 4, 5 can use. Client profiles 12 are optionally set individually for each client. However, standardized default client profiles can be set for convenience. A client profile 12 could include parameter settings for:

1) The client type and status.

2) Authorization parameters controlling what the client 3, 4, 5 can do and can't do.

3) Controlling packet size and bandwidth on the link to the client.

4) The maximum individual usage of network resources including bandwidth between the various nodes in the application network 1, memory usage in the various nodes of the application network 1. The bandwidth usage on the access link to the client is controlled.

5) Client group membership.

7) Communication protocol and application protocol settings and sizes of protocol fields and application tags.

8) The total allowed connection time and various time-out settings.

Format of Profiles

A client or session profile 11, 12 is a file or a database record that includes the following elements:

1) a profile name

2) optionally the name of the application session APS including its version number

3) optionally comments and other information for human readers

4) A list of application network parameters according to any suitable format, e.g.

i) a list of parameter name followed by a parameter value

ii) a list of parameter values where the position in the list indicates the parameter type

Application Server (AS)

An application server AS receives application data and stores application data. The application server AS distributes application data to application clients 3, 4 according to queries, requests or subscriptions. Such queries, requests or subscriptions may be expressed in terms of subscriptions to application data units 6 carrying application tags (see below). Computer memory for application data and for subscriptions and processing resources are reserved for an application session APS according to the session profile 11 and for an application client according to the client profile 12.

Application Client (AC)

An application client AC is a local instance of the computer process that is simulating the networked virtual environment. An application client AC could e.g. be a Windows/UNIX process or thread. One computer process could run one or several application clients AC. An application client is thus a logical instance of a game or simulation and is not always identical to any specific computer process, thread, program or machine. The participant computers 3, 4 or for example a game console 7 that is running the application client AC have means for receiving input from the programmable application network and various inputs from users, as in SE . . . Fredriks, (through AR) and is displaying the output of the application as graphics, video, audio or haptic (physical sensing indication) output. The application client AC may subscribe to, receive and process tagged application data units 6 and send tagged application data units 6. The session profile 11 and the client profile 12 are used to configure the application client AS so that it communicates according to the session and client profiles.

Application Session Tickets 10

The Programmable application network accepts that a client 3, 4 joins an application session APS only if the client logs on with an Session access ticket 10 that confirms the client's right to use network resources according to a given client profile 11 and session profile. Clients with incorrect application tickets are rejected. The session access ticket 10 for a session participant to be connected to a particular session has such information to uniquely point out either

1. a client type for a specific session type for a specific game (a client profile and/or a session profile and/or an application name); or

2. A client in a specific session for a particular application.

Case 1 is preferable to use if the programmable application network PAN is run without session management interface I.

This information may be encoded according to any feasible method. This makes it possible for the programmable application network 1 to perform a simple authorization test of the client and at the same time set the client specific parameters.

Thus, the programmable application network performs an authorization test of the client by means of the coded session access ticket 10 and sets simultaneously the client specific parameters.

Application Router (AR)

An application router AR is routing application data units 6. The session access ticket 10 is sent to the application router AR. The participants are then connected to the application router R through the application client AC and from there to the programmable application network 1. The routing is dependent on the application tags (see below) carried by each application data unit 6. The application router AR receives data-grams containing application data units from the Communication Network 2. The application router AR reads the application tags of the application data units 6 and resends the application data units 6 over the Communication Network 2 with a network address that depends on the application tags and possibly also on Client subscriptions. Computer memory for routing tables and for client subscriptions and processing resources are reserved for an application session APS according to the session profile 11 and for an application client AC according to the client profile 12.

Application Content Generator (ACG) (Optional)

An application content generator ACG is a server that generates content for an application session APS. It might e.g. be a game server in multi-player games that makes decisions about kills, collisions and damage. It might also be responsible for 4 running avatars that appear to be human-controlled but are managed by artificial intelligence. The application content generator ACG receives and processes application data units 6 and sends application data units 6 carrying application tags. Computer memory for application data and processing resources are reserved for an application session according to the session profile and for an application client according to the client profile.

Application Session Name Server (ASNS) (optional)

The optional ASNS maps application session names to application tags in application data units 6 and vice versa and responds to operations such as setting names, removing names and inquiring about names. It will be described in detail below. Computer memory for application databases and processing resources are reserved for an application session APS according to the session profile 11 and for an application client according to the client profile 12.

Accounting System 8

An accounting system 8 could measure the properties of an application session APS including the start and stop time of the session and the join and leave time of each client 3, 4. The session profile 11 and the client profile 12 are known by the accounting system 8 and give a description of the network resources, which have been used by the session and by each client 3, 4. This means that the amendments a profile parameter, such as an ALS, could demand. The used session and client profiles could be different that the ones stored, since the ALS can amend individual parameters in the ALS for a session and per participant. The accounting system 8 calculates charges for clients, application service providers, application lobby service providers, and operators according to the business model of the service.

Client Authentication Server (CAS) (optional)

Clients 3, 4 may log in at the optional client authentication server CAS before joining an application session APS. The optional client authentication server CAS may be connected to a user database and reports optionally to the Accounting System 8. The optional client authentication server CAS is used for ensuring that clients correspond to known users that have a customer account. The client authentication server CAS is optionally connected to the application lobby server ALS for authorization of the ALS.

Application Profile Database (APDB)

Default session profiles and client profiles are stored in the application profile database APDB. Each type of application (e.g. the computer game Quake m Arena) may have one or several associated session profiles 11 and client profiles 12 in the database APDB. Each session or client profile may have a name, so that they can be retrieved by referring to the name.

Communication Protocols

Network Protocols 9

The communication network is typically using several packet-based communication protocols e.g. IP protocols 9. The communication network 2 carries data-grams from senders to receivers. A data-gram consists typically of a Header and a Payload. A Header may include one or several network addresses that are used by Routers in the communication network for sending the data-gram to the receiver. Protocols 9 are often layered so that the payload of one protocol layer may include one or several data-grams of the next protocol layer. Application data units are carried as payload in the network protocol data-grams.

Application Transport Protocol

The Application may include its own communication protocol. The data-gram of is the application will here be called an application data unit 6. An application data unit 6 consists of several application tags and a payload. The payload consists of application specific data such as positions, avatar properties, coded voice data etc.

Application Tags

An application tag is a field in packet header or in an application data unit header. It consists hence of a set of bits. An application tag has a type that is marked by the corresponding field's position in the protocol or by flags in the protocol that indicates the type of the tag. If an application tag is a field in a general communication protocol it might be a network address, a multicast address or a port number. In the context of reference PCT/SE00/00932 it is an object identifier, a client identifier, a group identifier or a stream object key. Application tags should be as short as possible for saving network bandwidth.

The application session APS is typically a simulation of a virtual world. This world includes application items that are meaningful for the human users such as human participants, avatars controlled by humans, avatars controlled by AI, fixed roles in the game that may be switched between users (king, referee . . . ), objects in the virtual world, properties of objects and avatars, groups and teams of avatars, groups of objects, groups of groups, locations in the virtual world, media streams (voice, video) and collections of media streams. All such items may be identified by sets of application tags.

Programming the Application Network

Application Network Parameters

An application network parameter is a value of a controllable setting of any node in the programmable application network. The network behavior in communicating and storing application data is changed if an application network parameter is modified.

Starting a Session and Including Clients in a Session

Ticket handling when joining an existing application session

The programmable application network 1 may distribute session access tickets 10 via the session management interface I (in the case when the programmable application network I does not have a CAS; one of many cases). Clients 5 (and also participants which are already inserted in the system) that wishes to join or set up an application session APS will contact an ALS directly and optionally log in at the ALS by presenting a user name and a password across a secure communication link 2. The client could now either request that a new application session APS is set up or request to join an already existing application session APS.

The ALS sends the request further to the ANMS via the Session management interface I. The ALS receives a session access ticket(s) from the ANMS if the request was approved. The session access ticket(s) 10 could be distributed to the client by the ALS. The client can use the session access ticket(s) 10 to join, rejoin and disconnect to/from the application session.

The client contacts an access node, e.g. an application router AR, in the programmable application network 1 providing the session access ticket 10. The access nodes check that the session access ticket 10 is a valid. Clients presenting a valid session access ticket 10 are allowed to join the session APS.

An alternative way of using the session access ticket system may be to open the session for an application with a certain session profile for a fixed number of clients, N, that are using a given client profile named P. The ALS would then announce that the session is open for N clients of type P to join at one or several access nodes (identified by network addresses). The application ticket is identical to the client profile name or the application ticket is translatable to the client profile name. This means that N clients with the same application ticket (AT) 10 can join the session at the announced access node(s). The ANMS configures the access node(s) or the ALS, so that at the most N clients with application ticket AT can join. Any client can now join the session with the application ticket AT and be initialized with client profile P. A function like that is useful when it is suitable to start e.g. a driving game with 16 drivers. All drivers have identical roles and it doesn't matter for the service provider which users that join

Setting Up a New Application Session

The client might optionally negotiate the use of a specific session profile. The ALS could alternatively use a default session profile that is suitable for the application type. The ALS contacts the Application Network Management System (ANMS) and requests that resources are reserved in the programmable application network 1 for a new session APS according to the session profile 11. ALS may send the application name to the ANMS through the interface I. The session profile 11 is either sent by the ALS to the ANMS, or the name of the session profile is provided. A list of modified application network parameters might optionally be sent from the ALS to the ANMS. The transmitted parameter overrides the default parameters in the named session profile. The ANMS retrieves optionally the session profile that corresponds to the provided name from the Application Profile Database APDB. The application could either be identified by 1) the application name received from the ALS, inferred from the session profile name as e.g. a prefix, or 2) stored in conjunction with the session profile in the ANMS, or 3) be a parameter in the session profile.

The ANMS uses the session profile to configure the programmable application network for the new session. ANMS or ALS selects a session identifier that is used in communication between the ALS, the ANMS and other nodes to identify the session. The ALS signals to the communication network 2 by use a WWW interface or other means that the session now is available for clients to join. The client that requested the session to be set might automatically be joined.

Joining a Client to a Application Session

A client that wishes to join a specific application session might optionally negotiate the use of a specific client profile. The ALS could alternatively use a default client profile that is suitable for the client and the application type. The ALS contacts the Application Network Management Systern (ANMS) and requests that resources are reserved in the programmable application network for a new client. Either the client profile is sent by the ALS to the ANMS or the name of the client profile is provided. A list of modified application network parameters might optionally be sent from the ALS to the ANMS. The transmitted parameter overrides the default parameters in the named client profile. The ANMS retrieves optionally the client profile that corresponds to the provided name from an Application Profile Database (APDB).

The ANMS uses the client profile to configure the programmable application network and optionally the client computer or the client application for the new session. The client, ANMS or ALS selects a client identifier that is used in communication between the ALS, the ANMS and other nodes to identify the client.

Implementation Modes

Storage Location

The database of named session and client profiles could be stored in a database in a client machine, at the ALS, at the ANMS or in a separate APDB.

Accurate Business Models

The invention supports a wide range of business models for providing networked virtual environments as a commercial service to users. The following roles are supported:

A network operator could own and operate generic equipment such as the communication network, QAS, ANMS, APDB, AS, AR and ASNS.

An application service provider could own and operate application specific equipment such as ALS and ACG.

Application publishers provide software for clients and the ACG and provide also suitable default client and session profiles that are stored e.g. in the APDB.

The tasks of the different roles could be modified. One company could e.g. be both an application publisher and an application service provider. A specific node, e.g. the ALS, could alternatively be owned by a network operator, an application service provider or an application publisher.

End users could pay a flat fee, a per-minute charge or a charge that depends on used resources in the programmable application network 1 for enjoying an application session. The charge could be paid to either by a network operator, an application service provider or an application publisher. The accounting system calculates the charge according to the selected charging model. The party that receives the charge could forward a part of the charge to the other partners. A network operator could e.g. charge a user for an application session on the telephone bill. One part of the charge is forwarded to the application service provider and another part of the charge is forwarded to the application publisher.

The present invention enables a charging system where the splitting of the revenues between the different business roles can be performed with fairness and accuracy. The session profile and client profile accurately defines the resources that the session and client has used. The owners of the various nodes in the programmable application nodes could receive revenue that is in proportion to the resources that they have provided.

Although the invention is described with respect to an exemplary embodiment it should be understood that modifications can be made without departing from the scope thereof. Accordingly, the invention should not be considered to be limited to the described embodiment, but defined only by the following claims which are intended to embrace all equivalents thereof.

1. A configuration arrangement for flexible communication infrastructure for a multi-user application to be provided to a programmable application network (1), each user being a client (3, 4, 5) comprising a client computer and being able to participate in the application as a session participant, characterized by, in order to essentially avoid human supervising commanding operator after installation of the configuration means,
a) at least one session profile (11) comprising a set of application network parameters valid for an application session (APS), said session profile initializes and prepares the programmable application network (1) in connection with or before the start of the application session;
b) a number of client profiles (12), each comprising a set of application network parameters valid for the client participating in an application session, each said client profile initializes and prepares the programmable application network (1) and the client computer in connection with or before the joining of a given client (5) to the application session;
c) each client being provided with a session access ticket (10);
d) the session and client profiles (11, 12) associated with the application is adapted to give run-time conditions for the application session, if the programmable application network (1) does not support the application with a session management interface (I);
e) a session management interface (I) supporting the programmable application network support with the session and client profiles (11, 12) together with alterations to these agreed upon by the client in order to give the run-time conditions for the application session (APS); and
f) for both cases d) and e), the clients logon with their application session tickets (10).

2. A configuration arrangement according to claim 1, characterized in that the session access ticket (10) for a session participant to be connected to a session has such information to uniquely point out either a particular client and/or in a particular session and/or for a particular application or a client profile type and/or a session profile type and/or an application and/or a particular client.

3. A configuration arrangement according to claim 2, characterized in that an application name and/or session profile and/or a client profile identity and/or a client accen connection is provided as the session access ticket (10) for a session participant.

4. A configuration arrangement according to anyone of the preceding claims, characterized in that information about the session access ticket (10) is coded.

5. A configuration arrangement according to anyone or the preceding claims, characterized in that each application is associated to one or several client profiles (11) and application session profiles (12).

6. A configuration arrangement according to claim 2, characterized in that the programmable application network (1) performs an authorization test of the client by means of the coded session access ticket (10) and sets simultaneously the client specific parameters.

7. A configuration arrangement according to anyone of the preceding claims, characterized in that a set of client profiles (12) are associated to the at least one the session profile.

8. A configuration arrangement according to anyone of the preceding claims, characterized in that session participants can join the session using the session access ticket (10) provided by the programmable application network (1).

9. A configuration arrangement according to anyone of the preceding claims, characterized by negotiation means (ALS) through which a possible client (5) that wishes to initiate an application session (APS) negotiates the use of a certain session profile (11) with the programmable application network (1).

10. A configuration arrangement according to anyone of the preceding claims, characterized in that the negotiation means (ALS) provides a negotiation between the user and the programmable application network (1) about joining an application session using a certain client profile (12).

11. A data processing system for flexible communication infrastructure for a multi-user application to be provided to a programmable application network (1), in order to essentially avoid human supervising commanding operator after installation of the system, wherein each user being a client (3, 4, 5) comprising a client computer and being able to participate in the application as a session participant, characterized by,
a) at least one session profile (11) comprising a set of application network parameters valid for an application session (APS), said session profile initializes and prepares the programmable application network (1) in connection with or before the start of the application session;
b) a number of client profiles (12), each comprising a set of application network parameters valid for the client participating in an application session, each said client profile initializes and prepares the programmable application network (1) and the client computer in connection with or before the joining of a given client (5) to the application session;
e) each client being provided with a session access ticket (10);
d) the session and client profiles (11, 12) associated with the application are adapted to give run-time conditions for the application session, if the programmable application network (1) does not support the application with a session management interface (I);
e) a session management interface (I) supporting the programmable application network support with the session and client profiles (11, 12) together with alterations to these agreed upon by the client in order to give the run-time conditions for the application session (APS); and
f) for both cases d) and e), the clients logon with their application session tickets (10).

12. A data processing system according to claim 11, characterized in that the session access ticket (10) for a session participant to be connected to a session has such information to uniquely point out either a particular client and/or in a particular session and/or for a particular application or a client profile type and/or a session profile type and/or an application and/or a particular client.

13. A data processing system according to claim 12, characterized in that an application name and/or session profile and/or a client profile identity and/or a client accen connection is provided as the session access ticket (10) for a session participant.

14. A data processing system according to anyone of the claims 11 to 13, characterized in that information about the session access ticket (10) is coded.

15. A data processing system according to anyone or the claims 11 to 14, characterized in that each application is associated to one or several client profiles (11) and application session profiles (12).

16. A data processing system according to claim 12, characterized in that the programmable application network (1) performs an authorization test of the client by means of the coded session access ticket (10) and sets simultaneously the client specific parameters.

17. A data processing system according to anyone of the claims 11 to 16, characterized by a set of client profiles (12) are associated to the at least one the session profile.

18. A data processing system according to anyone of the claims 11 to 17, characterized in that session participants can join the session using the session access ticket (10) provided by the programmable application network (1).

19. A data processing system according to anyone of the claims 11 to 18, characterized by negotiation means (ALS) through which a possible client (5) who wishes to initiate an application session (APS) negotiates the use of a certain session profile (11) with the programmable application network (1).

20. A data processing system according to anyone of the claims 11 to 19, characterized in that the negotiation means (ALS) provides a negotiation between the user and the programmable application network (1) about joining an application session using a certain client profile (12).

21. A computer program product comprising a computer readable medium, having thereon:
computer program code means, when said program is loaded, to make the computer execute procedure to display information within a first window in a display of at least one client computer (7) for flexible communication infrastructure for a multi-user application to be loaded from the client computer (7) to a programmable application network (1), each user being a client (3, 4, 5) comprising a client computer and being able to participate in the application as a session participant, characterized by, in order to essentially avoid human supervising commanding operator after installation of the program in the programmable application network (1),
a) at least one session profile (11) comprising a set of application network parameters valid for an application session (APS), said session profile initializes and prepares the programmable application network (1) in connection with or before the start of the application session;
b) a number of client profiles (12), each comprising a set of application network parameters valid for the client participating in an application session, each said client profile initializes and prepares the programmable application network (1) and the client computer in connection with or before the joining of a given client (5) to the application session;
c) each client being provided with a session access ticket (10);
d) the session and client profiles (11, 12) associated with the application is adapted to give run-time conditions for the application session, if the programmable application network (1) does not support the application with a session management interface (I);
e) a session management interface (I) supporting the programmable application network support with the session and client profiles (11, 12) together with alterations to these agreed upon by the client in order to give the run-time conditions for the application session (APS); and
f) for both cases d) and e), the clients logon with their application session tickets (10).

22. A computer program product according to claim 21, characterized in that the session access ticket (10) for a session participant to be connected to a session has such information to uniquely point out either a particular client and/or in a particular session and/or for a particular application or a client profile type and/or a session profile type and/or an application and/or a particular client.

23. A computer program product according to claim 22, characterized in that an application name and/or session profile and/or a client profile identity and/or a client accen connection is provided as the session access ticket (10) for a session participant.

24. A computer program product according to anyone of the claims 21 to 23, characterized in that information about the session access ticket (10) is coded.

25. A computer program product according to anyone or the claims 21 to 24, characterized in that each application is associated to one or several client profiles (11) and application session profiles (12).

26. A computer program product according to claim 22, characterized in that the programmable application network (1) performs an authorization test of the client by means of the coded session access ticket (10) and sets simultaneously the client specific parameters.

27. A computer program product according to anyone of the claims 21 to 26, characterized by a set of client profiles (12) are associated to the at least one the session profile.

28. A computer program product according to anyone of the claims 21 to 27, characterized in that session participants can join the session using the session access ticket (10) provided by the programmable application network (1).

29. A computer program product according to anyone of the claims 21 to 28, characterized by negotiation means (ALS) through which a possible client (5) that wishes to initiate an application session (APS) negotiates the use of a certain session profile (11) with the programmable application network (1).

30. A computer program product according to anyone of the claims 21 to 29, characterized in that the negotiation means (ALS) provides a negotiation between the user and the programmable application network (1) about joining an application session using a certain client profile (12).
